(19) United States
(12) Patent Application Publication
(10) Pub. No.: US 2014/0177772 A1
(43) Pub. Date: Jun. 26, 2014

(54) APPARATUS AND METHOD FOR CONTROLLING GAIN ACCORDING TO RATE OF CHANGE IN WATER LEVEL OF STEAM GENERATOR IN NUCLEAR POWER PLANTS

(71) Applicant: KEPCO ENGINEERING & CONSTRUCTION COMPANY, INC., Yongin-si (KR)

(72) Inventors: See Chae JEONG, Gyeonggi-Do (KR); Ju Han LEE, Daejeon (KR); Jong Joo SOHN, Daejeon (KR); Myung Jun SONG, Daejeon (KR); Chan Eok PARK, Daejeon (KR)

(73) Assignee: KEPCO ENGINEERING & CONSTRUCTION COMPANY, INC., Yongin-si (KR)

(21) Appl. No.: 14/134,251

(22) Filed: Dec. 19, 2013

(30) Foreign Application Priority Data
Dec. 26, 2012 (KR) 10-2012-0153703

(51) Int. Cl. G21D 3/00

(52) U.S. Cl. CPC G21D 3/00
USPC 376/215

(57) ABSTRACT

Provided is an apparatus for controlling a gain according to a water level change rate of a steam generator in nuclear power plants. The apparatus includes a water level variance detector detecting a water level variance of the steam generator, a change rate calculator calculating a water level change rate with respect to the detected water level variance, a compensation value calculator calculating a compensation gain value corresponding to the calculated water level change rate, a reactor power sensor sensing whether or not reactor power corresponds to certain power or less, and a gain compensation controller, when the reactor power corresponds to the certain power or less, outputting a control gain value obtained by combining a general gain value provided to control a proportional-integral (PI) controller with the compensation gain value to the PI controller

### RELATED APPLICATIONS

This application claims the benefit of Korean Patent Application No. 10-2012-0153703, filed on Dec. 26, 2012, in the Korean Intellectual Property Office, the disclosure of which is incorporated herein in its entirety by reference.

### BACKGROUND

1. Field

One or more embodiments of the present invention relate to a method of controlling a water level of a steam generator in nuclear power plants, and more particularly, to a method of relieving non-linear behavior of steam generator water level, caused by the low temperature feedwater at the low power operation mode.

2. Description of the Related Art

General steam generator level control systems drive a downcomer feedwater control valve, an economizer feedwater control valve, and main feedwater pumps by performing control logic implemented in a proportional-integral (PI) controller with steam generator water level, feedwater flow, and steam flow as input signals, thereby controlling a downcomer level of steam generator to be maintained around a setpoint.

FIG. 1 is a schematic view of control logics of a general feedwater control system (FWCS) for nuclear power plants. The FWCS control mode is transferred at 20% of reactor power between low and high power operation modes. In the high power mode, a downcomer feedwater control valve is placed at the constant position to maintain 10% rated feedwater flow and controls a water level by using an economizer feedwater control valve. In the low power mode, the economizer feedwater control valve is fully closed, and the water level is controlled by only using the downcomer feedwater control valve. In the low power mode, since feedwater flow and steam flow signals are not available, control is performed by only using a water level signal.

Feedwater to the steam generator is supplied after heated by using steam extracted from high pressure and low pressure turbines through a feedwater heater. Feedwater at low power is supplied at a relatively lower temperature because an amount of steam generated by the steam generator is smaller than a full power condition.

FIG. 2 is a graph illustrating a temperature of feedwater of a steam generator according to reactor power. The temperature of the feedwater according to the reactor power, as shown in FIG. 2, is maintained within a minimum and maximum feedwater temperature design range. Particularly, as shown by a dashed circle, when the reactor operates at 20% or less of the power thereof, since the temperature of feedwater is relatively lower comparing with a full power operation, the nonlinear behavior of steam generator water level is intensified due to shrink/swell phenomena of an inventory of the steam generator.

Under a low temperature feedwater condition, a shrink/swell phenomenon of a water level of the steam generator results in cyclic process with the order of water level decreasing, feedwater flow increasing, water condensation in the steam generator accelerating, water level shrinking, the supplied feedwater heated enough, and then the water level increasing as much as the amount of the previously supplied feedwater although the feedwater flow is reduced. The shrink/swell phenomena of the water level of the steam generator under the low temperature feedwater condition described above is demonstrated in the actual operation data of nuclear power plants.

FIG. 3 is a view illustrating a range of fluctuation in a water level of a steam generator according to a feedwater temperature of the steam generator. As shown in FIG. 3, when low temperature feedwater is supplied, the automatic operation of the feedwater control system results in a bigger fluctuation in the water level of the steam generator. Under a condition in which a feedwater temperature is high, the range of fluctuation in the water level of the steam generator is relatively reduced.

### SUMMARY

One or more embodiments of the present invention relate to a method of automatically controlling gain of proportional-integral (PI) controller according to a water level variation to reduce water level transient phenomena of the steam generator, occurring when a low temperature feedwater is supplied at the low power operational mode. The apparatus for controlling gains according to the change in steam generator water level operates to respond to non-linear behavior of steam generator water level caused by low temperature feedwater as follows: When the water level variance of the steam generator is great at the low power operational mode, the change in PI controller output can be slowed by reducing gain. When the water level variance of the steam generator is small, the change in PI controller output can be normalized by increasing gain.

Additional aspects will be set forth in part in the description which follows and, in part, will be apparent from the description, or may be learned by practice of the presented embodiments.

According to one or more embodiments of the present invention, an apparatus for controlling a gain according to a water level change rate of a steam generator in nuclear power plants includes a water level variance detector detecting a water level variance of the steam generator, a change rate calculator calculating a water level change rate with respect to the detected water level variance, a compensation value calculator calculating a compensation gain value corresponding to the calculated water level change rate, a reactor power sensor sensing whether or not reactor power corresponds to certain power or less, and a gain compensation controller, when the reactor power corresponds to the certain power or less, outputting a control gain value obtained by combining a general gain value provided to control a proportional-integral (PI) controller with the compensation gain value to the PI controller.

The certain power may correspond to any value from about 10 to about 30% of a full reactor power.

The gain compensation controller, if the reactor power corresponds to the certain power or less, may control the control gain value to be outputted in inverse proportion to the water level change rate.

The gain compensation controller, if the reactor power is more than the certain power, may only control the control gain value, excluding the compensation gain value, to be outputted to the PI controller.

According to one or more embodiments of the present invention, a method of controlling a gain according to a water level change rate of a steam generator in nuclear power plants includes detecting a water level variance of the steam generator, calculating a water level change rate with respect to the detected water level variance, calculating a compensation gain value corresponding to the calculated water level change rate, sensing whether or not reactor power corresponds to a certain power or less, and outputting a control gain value obtained by combining a general gain value provided to control a proportional-integral (PI) controller with the compensation gain value to the PI controller, when the reactor power corresponds to the certain power or less.

The outputting of the control gain value to the PI controller may include outputting the control gain value in inverse proportion to the water level change rate when the reactor power corresponds to the certain power or less.

The method may further include only outputting the control gain value, excluding the compensation gain value, to the PI controller when the reactor power is more than the certain power.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a general feedwater control system for control logic for a water level of a steam generator in nuclear power plants;

FIG. 2 is a graph illustrating a temperature of feedwater of a steam generator according to reactor power;

FIG. 3 is a view illustrating a range of fluctuation in a water level of a steam generator according to a feedwater temperature of the steam generator;

FIG. 4 is a schematic view of a feedwater control system including an apparatus for controlling a gain according to a water level change rate of a steam generator of nuclear power plants according to one or more embodiments of the present invention;

FIG. 5 is a block diagram of the apparatus of FIG. 4;

FIG. 6 is a graph illustrating a result of comparing water levels of the steam generator when power of a low power reactor is increased/cut back; and

FIG. 7 is a flowchart of a method of controlling a gain according to a water level change rate level of a steam generator of nuclear power plants, according to one or more embodiments of the present invention.

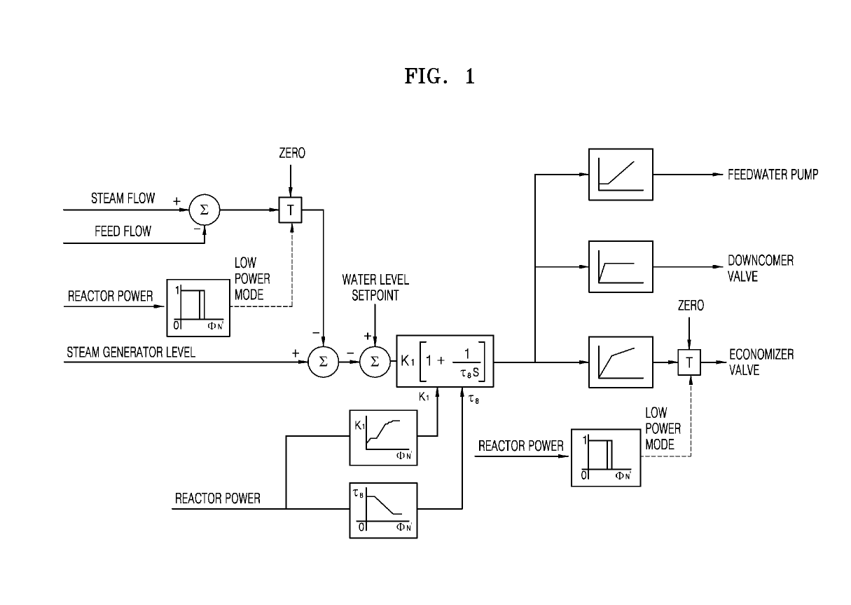

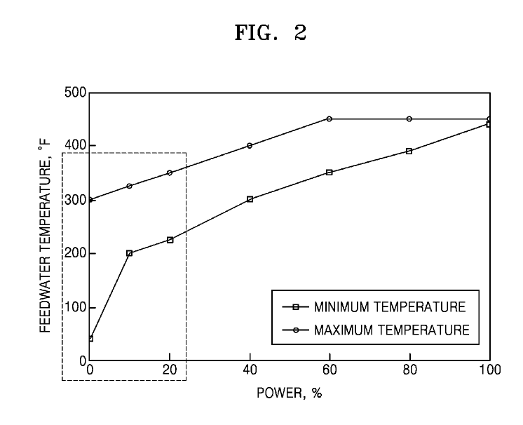

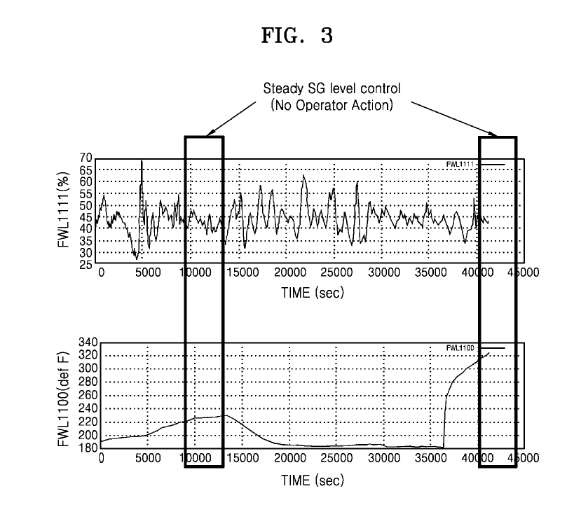

### DETAILED DESCRIPTION

Hereinafter, embodiments of the present invention will be described with reference to the attached drawings.

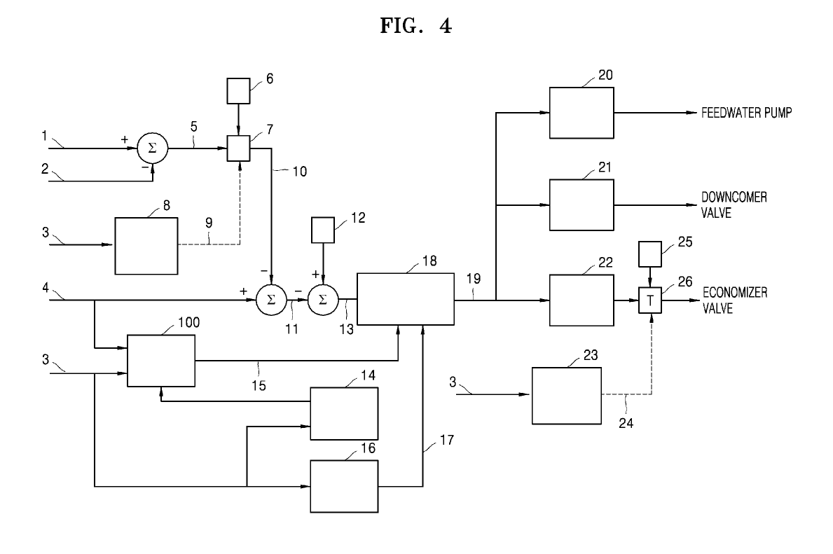

FIG. 4 is a schematic view of a feedwater control system including an apparatus 100 for controlling a gain according to a water level change rate level of a steam generator of nuclear power plants, according to one or more embodiments of the present invention.

In FIG. 4, there are a steam flow 1, a feed(water) flow 2, a reactor power 3, a steam generator level 4, a steam-feedwater flow deviation 5, zero 6, a transfer logic 7 allowing a value provided from the zero 6 to be outputted when an input provided from a signal 9 for low reactor power control and allowing a value provided from the steam-feedwater flow deviation 5 to be outputted when the input is 0, a low reactor power control program 8, the signal 9 for low reactor power control, a steam flow-feedwater flow deviation 10, a steam generator level-steam flow-feedwater flow deviation 11, a steam generator level setpoint 12, a compensated steam generator level error 13, a gain controller 14, a control gain value 15, a reset time constant program 16, a reset time constant 17, a proportional-integral (PI) controller 18, a flow demand signal 19, a main feedwater pump speed program 20, a downcomer feedwater control valve position program 21, an economizer feedwater control valve position program 22, a low reactor power control program 23, a signal 24 for low reactor power control, zero 25, a transfer logic 26 allowing a value provided from the zero 25 to be outputted when an input provided from the signal 24 for low reactor power control is 1 and allowing a value provided from the economizer feedwater control valve position program 22 to be outputted when the input is 0. Since elements described above are identical to elements of a general feedwater control system for water level control logic, a description thereof in detail is omitted.

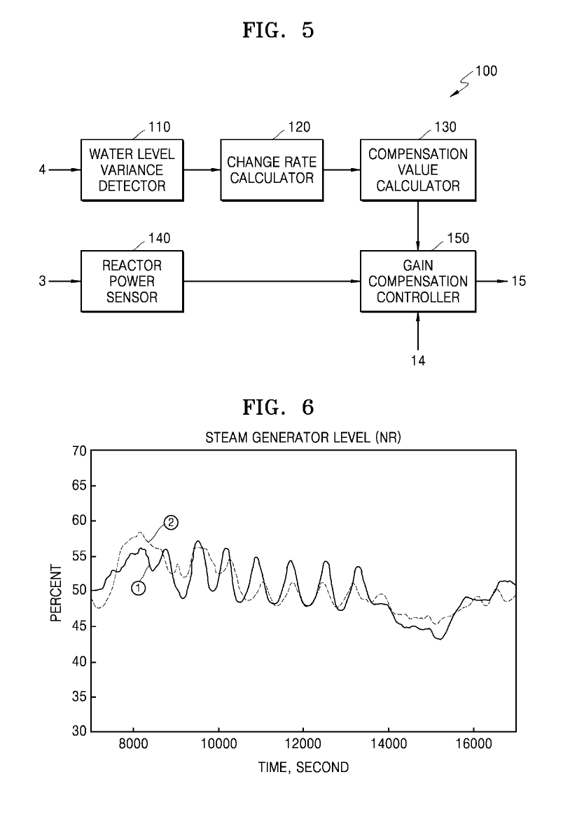

The apparatus 100 for controlling the gain according to the water level change rate level of the steam generator in the nuclear power plants is newly added to a general feedwater control system and will be described in detail with reference to FIG. 5.

FIG. 5 is a block diagram of the apparatus 100. The apparatus 100 includes a water level variance detector 110, a change rate calculator 120, a compensation value calculator 130, a reactor power sensor 140, and a gain compensation controller 150.

The water level variance detector 110 detects a water level variance according to the steam generator level 4 and outputs a signal with respect to the detected water level variance to the change rate calculator 120. The water level variance detector 110 calculates the water level variance by obtaining an absolute value from a variation value of the water level, for each execution interval of an algorithm.

The change rate calculator 120 calculates a water level change rate level with respect to the water level variance detected by the water level variation detector 110 and outputs a signal with respect to the calculated water level change rate level to the compensation value calculator 130. The change rate calculator 120 obtains a differential value with respect to the water level variance, thereby calculating each water level change rate level with respect to the water level variance.

The compensation value calculator 130 calculates a compensation gain value corresponding to the water level change rate and outputs a signal with respect to the calculated compensation gain value to the gain compensation controller 150. The compensation value calculator 130 includes information on a table with respect to compensation gain values corresponding to the water level change rates to calculate the compensation gain values. The compensation value calculator 130 calculates a compensation value to provide the PI controller with a smaller gain value as a value of the water level change rate increases.

On the other hand, the reactor power sensor 140 senses whether the reactor power 3 corresponds to certain power or less and outputs a sensed signal to the gain compensation controller 150. Herein, the certain power is a reference value for determining whether or not the reactor power 3 is low, which may be a value arbitrarily determined corresponding to any value from about 10 to about 30% of a full reactor power. For example, when the certain power is determined as about 20%, the reactor power sensor 140 determines whether the reactor power 3 corresponds to about 20% or less of the full reactor power, based on the certain power.

The gain compensation controller 150 outputs a control gain value 15 obtained by combining a general gain value provided by the gain controller 14 with a compensation gain value to the PI controller 18 when a signal sensed by the reactor power sensor 140 is determined as corresponding to the certain power or less.

The gain compensation controller 150 controls the control gain value 15 to be outputted in inverse proportion to the water level change rate when the reactor power 3 corresponds to the certain power or less. For example, in a case, in which the certain power is determined as about 20%, when the reactor power corresponds to about 20% or less, the gain compensation controller 150 allows an output of the PI controller 18 to be gradually changed by decreasing a gain of the PI controller 18 when a change of the steam generator level is great in a low power operation section with reactor power of 20% or less. Also, when the change of the steam generator level is small, the output of the PI controller 18 is allowed to have a normal change rate by increasing the gain, thereby corresponding to the nonlinearity of controlling the steam generator level, caused by feedwater at a low temperature.

On the other hand, the gain compensation controller 150 controls the control gain value 15 excluding the compensation gain value to be outputted to the PI controller 18 when the reactor power 3 is more than the certain power. For example, in a case, in which the certain power is determined as about 20%, in a high power section, in which the reactor power 3 corresponds to 20% or more, the gain compensation controller 150 only outputs the general gain value provided by the gain controller 14 to the PI controller 18 while excluding the compensation gain value provided by the compensation value calculator 130.

FIG. 6 is a graph illustrating a result of comparing water levels of the steam generator when power of a low power reactor is increased/cut back. \textcircled{1} is a result of comparing the steam generator levels in a general manner while a load of nuclear power plants is changed, that is, the reactor power is changed in a low power operation section. \textcircled{2} is a result of comparing the steam generator levels according to an embodiment of the present invention while a load of nuclear power plants is changed in the low power operation section. According to one or more embodiments of the present invention, rather than the general manner, a range of fluctuation in the steam generator level caused by the reactor power may be drastically mitigated in the low power operation section.

Hereinafter, a method of controlling a gain, according to embodiments of the present invention, will be described with reference to the attached drawings.

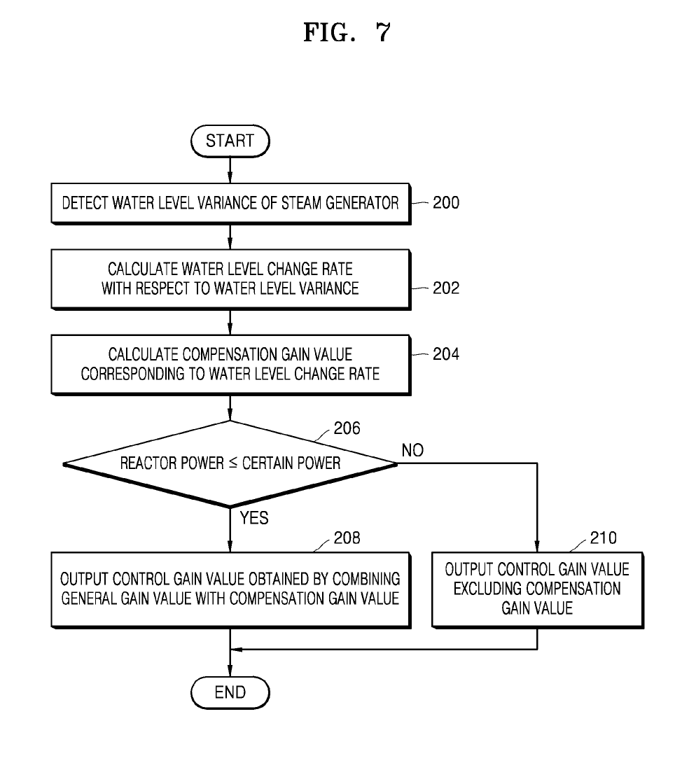

FIG. 7 is a flowchart of a method of controlling a gain according to a water level change rate of a steam generator in nuclear power plants, according to one or more embodiments of the present invention.

A water level variance of the steam generator is detected (200). The water level variance is calculated by obtaining an absolute value from a variance value of the water level, for each execution interval of an algorithm.

After operation 200, a water level change rate with respect to the detected water level variance is calculated (202). Each water level change rate with respect to the water level variance is calculated by obtaining a differential value with respect to the detected water level variance.

After operation 202, a compensation gain value corresponding to the calculated water level change rate is calculated (204). Systematically, information on a table with respect to compensation gain values corresponding to the water level change rates, respectively, is provided. A compensation value is calculated to allow a value of the water level change rate to increase when a smaller control gain value is to be provided to a PI controller.

After operation 204, it is determined whether or not reactor power corresponds to certain power or less(206). The certain power is a reference value for determining whether or not the reactor power is low and may be determined as any value from about 10 to about 30% of the full reactor power. For example, when the certain power is set as about 20%, based thereon, it is determined whether the reactor power corresponds to 20% or less or not.

After operation 206, if the reactor power corresponds to the certain power or less, a control gain value obtained by combining a general gain value provided by the gain controller 14 with the compensation gain value is outputted to the PI controller (208). The operation of outputting the control gain value to the PI controller includes, if the reactor power corresponds to the certain power or less, outputting the control gain value in inverse proportion to the water level change rate to the PI controller. For example, when the certain power is set as 20%, in an operation section with the reactor power of 20% or less, which is a low power section, when a change in a steam generator level is great, a gain of the PI controller is reduced to allow an output of the PI controller to be gradually changed. Also, when the change is small, the gain is increased to allow the output of the PI controller to have a normal change rate, thereby corresponding to the nonlinearity of controlling the steam generator level, caused by feedwater at a low temperature.

In operation 206, if the reactor power is more than the certain power, the control gain value excluding the compensation gain value is outputted to the PI controller (210). For example, when the certain power is set as 20%, in a high power section, in which the reactor power corresponds to more than 20%, excluding a compensation gain value, only a general gain value provided by the gain controller 14 is outputted to the PI controller.

As described above, according to the one or more of the above embodiments of the present invention, there is provided an effect of notably easing an excessive water level phenomenon of a steam generator by effectively controlling a contraction/expansion effect of a water level of the steam generator, caused by feedwater at a low temperature in a low power operation section.

Through this, a possibility of shutdown of a reactor, caused by an excessive fluctuation in a water level of a steam generator while reactor power is increased/cut back in a low power section, may be reduced, thereby drastically reducing a load on an operator and contributing to increasing a coefficient of utilization and economic feasibility of nuclear power plants

On the other hand, the method described above may be embodied as codes/instructions/programs that can be computer readable. For example, the method can be implemented in general-use digital computers that execute the codes/instructions/programs using a computer-readable recording medium. Examples of the computer-readable recording medium include magnetic storage media (e.g., ROM, floppy disks, hard disks, magnetic tapes, etc.) and optical recording media (e.g., CD-RMOs or DVDs).

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. An apparatus for controlling a gain according to a water level change rate of a steam generator in nuclear power plants, the apparatus comprising:
a water level variance detector detecting a water level variance of the steam generator;
a change rate calculator calculating a water level change rate with respect to the detected water level variance;
a compensation value calculator calculating a compensation gain value corresponding to the calculated water level change rate;
a reactor power sensor sensing whether or not reactor power corresponds to certain power or less; and
a gain compensation controller, when the reactor power corresponds to the certain power or less, outputting a control gain value obtained by combining a general gain value provided to control a proportional-integral (PI) controller with the compensation gain value to the PI controller.

2. The apparatus of claim 1, wherein the certain power corresponds to a any value from about 10 to about 30% of a full reactor power.

3. The apparatus of claim 1, wherein the gain compensation controller, when the reactor power corresponds to the certain power or less, controls the control gain value to be outputted in inverse proportion to the water level change rate.

4. The apparatus of claim 1, wherein the gain compensation controller, when the reactor power is more than the certain power, only controls the control gain value, excluding the compensation gain value, to be outputted to the PI controller.

5. A method of controlling a gain according to a water level change rate of a steam generator in nuclear power plants, the method comprising:
detecting a water level variance of the steam generator;
calculating a water level change rate with respect to the detected water level variance;
calculating a compensation gain value corresponding to the calculated water level change rate;
sensing whether or not reactor power corresponds to certain power or less; and
outputting a control gain value obtained by combining a general gain value provided to control a proportional-integral (PI) controller with the compensation gain value to the PI controller, if the reactor power corresponds to the certain power or less.

6. The method of claim 5, wherein the outputting of the control gain value to the PI controller comprises outputting the control gain value in inverse proportion to the water level change rate if the reactor power corresponds to the certain power or less,.

7. The method of claim 5, further comprising only outputting the control gain value, excluding the compensation gain value, to the PI controller when the reactor power is more than the certain power.
